(19) United States
(12) Patent Application Publication
(10) Pub. No.: US 2011/0236680 A1
(43) Pub. Date: Sep. 29, 2011

(54) METHOD FOR PRODUCING COMPONENTS FOR HIGH TEMPERATURE APPLICATIONS AND METAL COMPONENT

(75) Inventors: Peter Jahrling, Bunde (DE); Lars Schrubke, Kirchlengem (DE); Willi Crigat, Gutersloh (DE)

(73) Assignee: PAUL HETTICH GMBH & CO. KG, Vahrenkampstrasse 12-16 (DE)

(21) Appl. No.: 13/132,331

(22) PCT Filed: Dec. 2, 2009
(86) PCT No.: PCT/EP2009/066273

§ 371 Date: Jun. 2, 2011

(30) Foreign Application Priority Data
Dec. 2, 2008 (DE) 10 2008 059 908.5
Oct. 27, 2009 (DE) 10 2009 044 340.1

(51) Int. Cl. B32B 15/04; B05D 3/02; B05D 5/10; B05D 3/06; B05D 3/12; B32B 9/04; B32B 18/00; B32B 27/28; B32B 5/00

(52) U.S. Cl. 428/339; 427/385.5; 427/207.1; 427/508; 427/387; 427/374.1; 427/290; 428/704; 428/450; 427/379

(57) ABSTRACT

A method for the production of a component, the method steps including: providing a blank; applying an inorganic-organic hybrid polymer layer to a surface of the blank to form a coated blank; heating the coated blank until a curing of the polymer layer occurs; and cooling the coated blank. A component produced according to the method.

This application is a national stage of International Application PCT/EP2009/066273, filed Dec. 2, 2009, and claims benefit of and priority to German Patent Application Nos. 10 2008 059 908.5, filed Dec. 2, 2008 and 10 2009 044 340.1 filed Oct. 27, 2009, the content of which applications are incorporated by reference herein.

### BACKGROUND AND SUMMARY

The present disclosure relates to a method for the production of a component and a component, for use in domestic appliances, made according to the method, and the use of the component as a rail in a variety of domestic appliances and as a furniture fitting.

In the provision of components, especially metallic fittings, side grids and cooking-product supports, it is known to make components from self-passivating stainless steels. Surface passivation mostly occurs with a chromium content of more than 12%, thus forming a chromium oxide layer with a thickness of 2 to 4 nm. This passive layer protects the component from corrosion and prevents direct contact of the metal with another medium. The passivation by a chromium oxide layer comes with the advantage to be self-passivating, which means that upon removal of the chromium oxide by scratches on the surface new passivating chromium oxide will automatically form from the underlying chromium layer upon contact with atmospheric oxygen.

For the formation of an even passive layer in the passivation, a number of conditions need to be fulfilled in addition to the chromium content. These are mainly a metallically pure surface and sufficient oxygen in order to ensure complete oxidation along the surface. If these conditions are not fulfilled, no spontaneous oxide layer can be formed at high temperatures, such temperatures from 450° C. In the case of self-passivating stainless steels, the resistance to corrosion will decrease and the formation of a porous chromium oxide layer will occur as a result of oxidization, which enables only a very low amount of protection from corrosion. That is why the use of self-passivating stainless steels is disadvantageous for the production of components for cooking and baking ovens in applications from 400° C.

DE 25 44 880 discloses a method for producing a wear-resistant cover on plastic or metal substrates which consists of a coating compound made of a titanium, aluminum or zirconium ester with at least two ester groups OR, an epoxy and/or acryloxysilane and optionally conventional additives and fillers. EP 0 973 958 discloses a method for providing a metallic surface with a glass-like layer, with a coating composition being applied to a metallic surface and this coating being subsequently thermally compressed at a temperature of at least 350° C. into a transparent glass-like layer.

It is doubtful whether the coating systems as mentioned above can also be applied to components with a broad application spectrum in the field of domestic appliances, for example, refrigerators at temperatures of −50° C. as well as pyrolysis furnaces at temperatures beyond 500° C. under the corrosive conditions prevailing there.

DE 10 2004 001 097 discloses a metallic substrate with a deformable glass-like coating, comprising the application of an alkali-silicate-containing coating sol onto the substrate and a subsequent thermal treatment in two stages. The first stage can be performed in an oxygen-containing atmosphere or in vacuum at a residual pressure of ≦15 mbar. The second stage is performed in an atmosphere low in oxygen until the complete densification and hardening of the glass-like layer. This method entails additional effort in producing and maintaining the different atmospheres during the thermal densification.

EP 1 137 729 discloses a coating for domestic appliances which is based on hydrolysable silanes and comprises at least one non-hydrolysable component. The hydrolysable silanes comprise epoxy groups of at least one non-hydrolysable substitute as well as a curing catalyst selected from the group of the Lewis bases of zirconium titanium or aluminum alkoxides and further nanoscale inorganic solids.

DE 10 2007 053 023 discloses a layering composition with an oxide compound and a method for coating substrates made of metal, among other things. A coating composition is applied first to the substrate, which coating composition represents the general formula of a silane, for example. This silane composition is then heated to a temperature of more than 400° C. under formation of an element/element oxide composite layer, whereupon this element oxide composite structure is heated and is solidified by local sintering by means of a laser, which requires additional apparatuses as compared with previous heating methods.

EP 0 928 457 discloses a method for producing substrates with high-temperature-resistant and UV-resistant transparent colored coatings, with the coating composition being able to form at least one glass-like crystalline or partly crystalline oxide and contains at least one member of the group of a metal compound and the cover will thermally solidify under formation of a coated substrate.

EP 0 729 442 discloses a method for producing a functional glass-like layer with at least one hydrolysable silane, at least one organosilane and at least one functional carrier for coloring the coating or for coloration or for improving the metallic visual appearance. Subsequently, this coating is thermally densified into a glass-like layer.

EP 1 068 372 A1 describes a method for protecting a metallic substrate from corrosion. A species X which is derived from the metal is formed during corrosion. In order to prevent the formation of such a species, the substrate is provided with a coating made of polysiloxanes, with the coating further comprising a species Z which enters into a species Y with the metal. The formation of the species Y shows a lower formation enthalpy then the formation of the species X. The formation of the species Y is therefore preferable. The thermal shock resistance over a range of −40° C. to 100° C. was confirmed. A thermal shock resistance which occurs over a range of −40° C. to 500° C. under the corrosive conditions in an oven, for example, are not disclosed in the document.

DE 10351467 discloses the substrate which comprises a double coating. This coating can be used in the interior of a baking oven for example. The double coating has a hydrophobic component which reacts with free OH-groups as an outer layer. The inner layer is an inorganic sol-gel layer, in which the outer hydrophobic layer is only applied at low temperatures of up to a maximum of 100° C. and is tightly chemically linked to the same by condensation reactions. Finally, the baking of the double-layer system on the surface of the object occurs in a further method step.

DE 10155613 discloses a method for coating surfaces by hybrid polymer materials and the coating solutions and compounds used therein. A layer made of silanes with organic residues and aluminum alkoxides is applied to the surface of the substrate and dried. The surface is then provided with a cover lacquer.

DE 10253839 A1 discloses a method for coating objects with metallic surfaces. At least one organosilane in the so-called sol-gel method is applied after and optionally provided pre-treatment step for activating the metallic surfaces and the thus obtained coating is transferred to a polysiloxane coating. This transfer of the coating into a polysiloxane coating preferably occurs by thermal treatment at temperatures of 100° C.

EP 0956373 discloses a method for providing a protective surface on a base alloy which contains iron, nickel and chromium. Elementary silicon and titanium with at least aluminum or chromium are deposited on the base alloy and heat-treated by producing a surface alloy.

Coated fittings and components with possibilities for application in the high-temperature range are disclosed in DE 102005039883. It describes an accessory for the baking oven, with the accessory having a base body made of metal, for example, of chromized steel and a pyrolysis-resistant coating. The coating material is glass-like and was applied to the base body from a liquid phase.

The present disclosure provides for a method which improves the resistance of components against environmental influences, especially when used in the high-temperature range.

The present disclosure relates to a method for the production of a component, the method steps include: providing a blank; applying an inorganic-organic hybrid polymer layer to a surface of the blank to form a coated blank; heating the coated blank until a curing of the polymer layer occurs; and cooling the coated blank. The present disclosure also relates to a component, for use in domestic appliances, the component being produced according to the method. The component is configured to be used as a rail in domestic appliances, including baking ovens, refrigerators, washing machines, and as a furniture fitting.

Thus, as noted above, the method for producing a component, for example, for high-temperature applications includes providing a blank, which blank may be made by punching and bending a metal sheet, and applying an inorganic-organic hybrid polymer layer to the surface of the blank. The method further includes a heating of the coated blank, for example, to a temperature of at least 400° C., and a cooling of the coated blank to room temperature. A blank is thus created which offers good resistance to corrosion even at high temperatures. In the coating of the component for use in baking ovens, refrigerators and the like, it was surprisingly noticed that the surface which was previously provided with an inorganic-organic hybrid polymer layer was proved to be sufficiently resistant only after a thermal treatment in order to meet the endurance tests.

The blank can be made of metal, for example, special steel, steel, aluminum, aluminum alloys, copper, copper alloys, zinc, chromium nickel. The inorganic-organic hybrid polymer layer can also be applied to blanks which were already coated with PTFE, that is, polytetrafluoroethylene, or PEEK, that is polyetheretherketone. The hybrid polymer layer can also be applied to LCP, that is, liquid crystal polymer, thermoplastics, ceramics and enamel. A large variety of methods for shaping can be applied during the production process of the blank, depending on the configuration of its material.

Since the steps of the method can also be automated, application in a series production is within the scope of the present disclosure. The inorganic-organic hybrid polymer coating and the subsequent thermal treatment lead to improved protection from corrosion even in the higher temperature range as compared to previous passivation.

Following a subsequent thermal treatment for curing, the obtained polymer forms a hard layer which additionally is more resistant to tearing than would be the case in the application of a purely inorganic material, for example. This additional strength of the coating, as a result of the thermal treatment, therefore makes it more resistant to mechanical abrasion and ensures maintenance-free use of the components which are produced with the method according to the present disclosure.

It is proven to be advantageous, in accordance with the present disclosure, to apply the inorganic-organic hybrid polymer to the surface of the blank by a sol-gel method. Polar groups are created at first by hydrolysis which converts the dissolved starting substance into a sol. This viscous sol is distributed completely over the surface of the blank with low consumption of material and will subsequently tightly adhere to the surface of the blank as a result of the gel formation.

In this process, spraying of the sol onto the surface of the blank can be applied, which is a simple method of application and which saves material, in accordance with the present disclosure.

The surfaces can be provided with oleophobic and hydrophobic properties by using fluoric silanes as the starting substance for the sol-gel method. They will thus become dirt-repelling.

UV, or ultraviolet, radiation provides advantageous curing of the coating, so that as a result of three-dimensional linking of the polymer layer the surface will become scratch-proof and resistant to abrasion. That is why the blank can be stored over a prolonged period of time after this step before it is further processed.

If there are no demands made on the surface quality, the treated components can also be used after this treatment step at low temperatures in refrigerating and/or freezing appliances and in baking ovens at application temperatures of between −50 to 600° C. Especially when used in refrigerators and freezers, it is thus possible to omit the expensive additional zinc layer on the components.

It is advantageous and within the scope of the present disclosure, to add further inorganic components such as SiO₂ and/or TiO₂ to the sol in order to achieve an additional improvement of the mechanical properties of the coating by integration of these components into the inorganic-organic hybrid polymer structure during polymerization.

Further aggregate materials can be compounds containing aluminum and/or manganese. These compounds can be integrated into the inorganic/organic hybrid polymer structure during hydrolysis. Aluminum and/or manganese can be integrated in the predominantly inorganic cross-linkage of the coating after a thermal treatment of the component up to 800° C.

An advantageous embodiment of the coating, according to the present disclosure, provides an inorganic-organic hybrid polymer which includes silicon, aluminum and/or titanium and which is resistant to temperatures up to 800° C., and in the range of 400 to 600° C. Aluminum, titanium and silicon-oxygen polymer compounds are inexpensive, easy to synthesize and chemically resistant to the majority of chemicals. As a result of their material properties, such polymers are widely used as building materials or coating materials and thus fulfill all the requirements which are placed on coating materials for the high-temperature application.

The treatment of the inorganic-organic hybrid polymer coating advantageously occurs according to a temperature program, with two different temperature gradients being used in a heat-up phase of the coated blank. The slow heat-up of the blank occurs at first from room temperature [symbol] ₀=0 to 40° C. to a middle temperature [symbol] ₁=80 to 200° C. This is followed by a considerably faster heat-up phase in order to achieve a respective target temperature [symbol] ₂. The coating is thus enabled to adjust to the changed conditions during the thermal expansion of the blank and to optionally reorient itself along the substrate surface. The controlled heat-up is therefore advantageous because cured coatings tend to the formation of cracks in the higher temperature range.

The inorganic-organic hybrid-polymer-coated blank may be tempered at least 20 minutes, or possibly more than 30 minutes, at least 200° C., or possibly 300 to 600° C. As a result, an adhesive, corrosion-resistant and substantially ageing-proof substrate-polymer compound is achieved. The pyrolysis cleaning of the oven occurs in this temperature range for example. The time of at least 20 or 30 minutes is advantageous, because an oxidation of the organic hybrid polymer components occurs at this high-temperature and a finely distributed and more tear-proof polymer layer is obtained after the oxidation of the organic components than when using only inorganic starting materials.

During the cooling phase, a high temperature gradient of 5 to 40 K/min, or possibly 15 to 25 K/min, is recommended, thus minimizing stresses to the material on the boundary surface by different thermal expansion and preventing disorders of structure in the material.

In an advantageous embodiment, according to the present disclosure, the coated blank is tempered at an air throughput of 30 to 90 L per minute, or possibly 50 to 70 L per minute, thus achieving the highest possible oxidation of the organic components of the hybrid polymer on the substrate surface and later exposition of the user by combustion products of a potential post-combustion of organic polymer components is excluded.

In accordance with an embodiment of the present disclosure, the component is smoothed prior to application of the inorganic-organic hybrid polymer layer in order to achieve the largest possible boundary surface between the forming polymer surface and the substrate surface and in order to obtain a low distance between the two surfaces. Prior to the coating, the component can have a surface roughness of a maximum of 500 nm, or for example, 300 to 500 nm, or possibly 300 to 400 nm, which improves adhesion of the polymer to the substrate surface. Cleaning methods, such as degreasing, can be used prior to the application of the inorganic-organic hybrid polymer layer.

A component produced with the method in accordance with the present disclosure can be used especially in baking ovens in the high-temperature range since the coating provides high sturdiness of the material and high temperature resistance. Foodstuffs are usually cooked in baking ovens and usually contain a large amount of water which will evaporate and deposit at other places. This leads to a high level of susceptibility to corrosion in components in a baking oven. Moreover, it is necessary to focus on a hygienically high-quality method of processing especially in this field of application.

Furthermore, a component coated according to the method in accordance with the present disclosure can be used as a fitting in other domestic appliances in the range of between −50° C. to 600° C. This includes, among other things, the use in refrigerators where high demands are placed on the resistance to corrosion by fittings, for example, by salt-spray misting tests and the like.

Furthermore, the coating can be arranged especially as a fitting such as hinge, hinged fittings, rail systems, cooked-product supports and pull-out guides, or as part of a fitting.

The inorganic-organic hybrid polymer coating also increases the resistance to corrosion during transport of components, especially the resistance to external climatic influences such as rain, snow, salt water, sea water mist and fog. Although containers are protected from external influences, condensates can still form in the interior. The current temperature and the humidity which are brought into the container during loading will influence the respectively current relative humidity in the container. The trapped air in the container, the cargo, its packaging or the storage material are sources of humidity. A coating is provided, in accordance with the present disclosure, which increases resistance to corrosion of the coated components, especially during sea transport. Furthermore, the use of the coated components in seawater climate is possible. In addition, the components can be used in the form of furniture fittings in kitchen and/or laboratory furniture which is used for storing detergents and chemicals.

Dyes and/or pigments can also be incorporated into the coating of the components, in accordance with the present disclosure. This is advantageous for achieving visual effects since possible tarnish of special steels can be covered by color or metallic finish.

If the component already has a PTFE or PEEK coating onto which the inorganic-organic hybrid polymer layer is applied, these pre-coated components can already be provided in a colored way.

The component, in accordance with the present disclosure, is especially suitable for the production of a pull-out guide. In particular, the rails of the pull-out guide can be coated accordingly.

Other aspects of the present disclosure will become apparent from the following descriptions when considered in conjunction with the accompanying drawings.

### BRIEF DESCRIPTION OF THE DRAWINGS

FIG. 1 shows a perspective view of a pull-out guide in accordance with the present disclosure.

FIG. 2 shows an exploded view of the pull-out guide of FIG. 1.

FIG. 3 shows a schematic temperature diagram for providing a coated component, in accordance with the present disclosure.

FIG. 4 shows a table with measured values on the composition of the component with a depth profile of 0 to 100 μm, in accordance with the present disclosure.

FIG. 5 shows a schematic view of the concentration progression of individual elements in the depth profile of the coated component, in accordance with the present disclosure.

FIG. 6 shows a layered view of a light-microscopic image documentation of a coated component, in accordance with the present disclosure.

FIG. 7 shows a layered view of image documentation by a scanning electron microscope of a coated component, in accordance with the present disclosure.

FIGS. 8a, 8b show a spectral recording and a measured value table of an SEM/EDX measurement for a non-coated section of a component, in accordance with the present disclosure.

FIGS. 9a, 9b show a spectral recording and a measured value table of an SEM/EDX measurement of a coating of a component, in accordance with the present disclosure.

FIGS. 10a, 10b show a spectral recording and a measured value table of an SEM/EDX measurement of a surface of a coated component, in accordance with the present disclosure.

### DETAILED DESCRIPTION

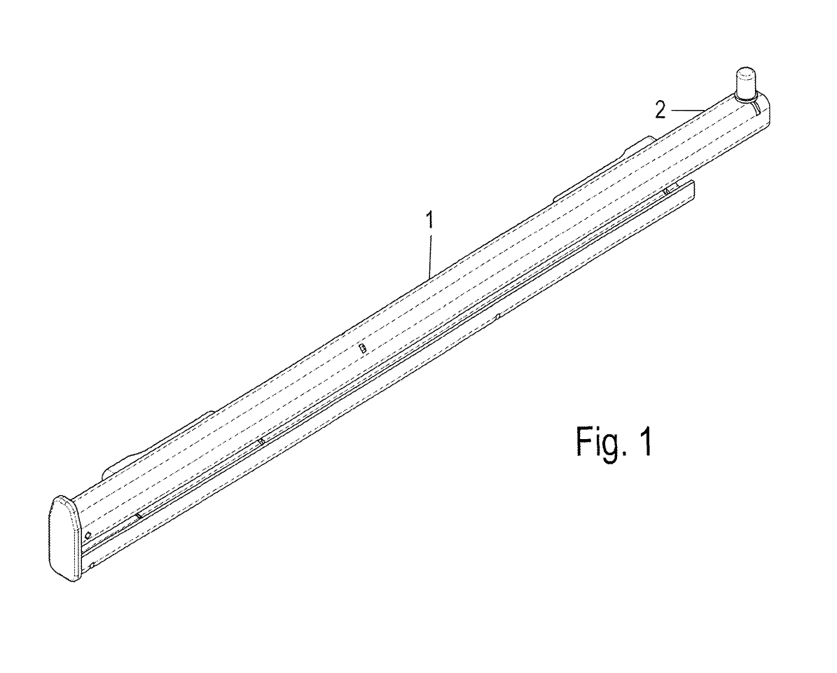

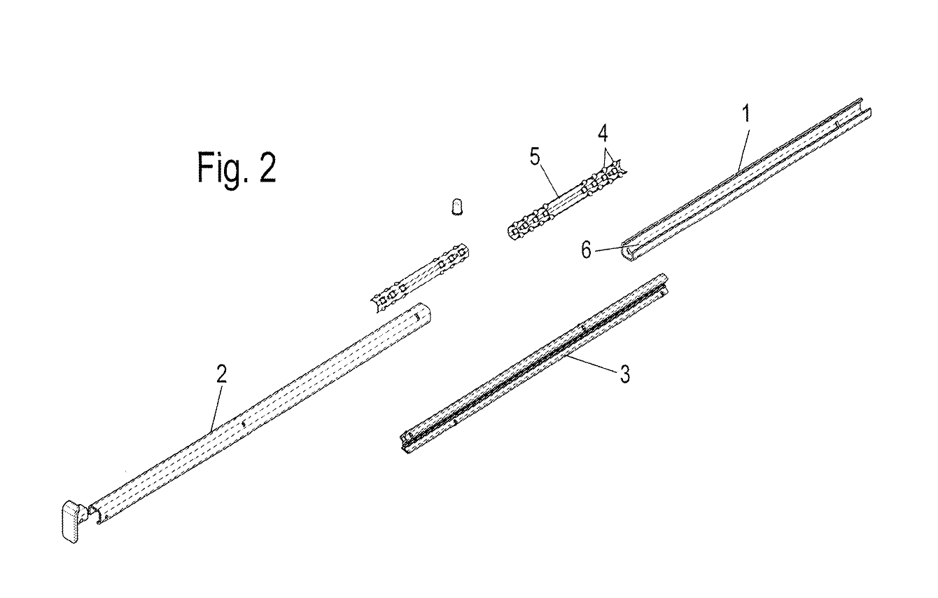

FIG. 1 shows a pull-out guide for high-temperature applications, for example, for baking ovens. The pull-out guide includes a guide rail 1 and a sliding rail 2 which is movable relative to the guide rail 1 and between which a middle rail 3, as shown in FIG. 2, is held. Pull-out guides are known which only include a guide rail 1 and a sliding rail 2. Furthermore, pull-out guides are used which include a guide rail 1, a sliding rail 2 and another rail. Rolling elements 4, made of, for example, a ceramic material, are provided for the displaceable mounting of the middle rail 3 and the sliding rail 2. Several tracks 6, for the spherical rolling elements 4, are, respectively, provided on the guide rail 1, the middle rail 3 and the sliding rail 2. The rolling elements 4 are guided spaced from one another in a rolling element cage 5 in order to prevent contact between them during rolling, which would thus impair smooth running.

The rails 1, 2 and 3 are made for use in baking ovens from a punched and bent steel sheet and are provided with a coating. The production of the components of the pull-out guide, especially the rails 1, 2 and 3, is performed by the following steps, in accordance with the present disclosure.

A metal blank of the pull-out guide is produced at first by punching and bending. The blank can be produced by machines. Thereafter, an inorganic-organic hybrid polymer layer is applied to the surface of the blank.

The surface of the blanks is pretreated beforehand. This occurs by smoothing of the surface and by chemical cleaning of any remaining grease residues by alkaline detergents, for example, with a pH=8 to 10.5.

The coated blanks are then heated to a temperature of at least 400° C. and tempered for a predetermined period of time before they are cooled again to room temperature.

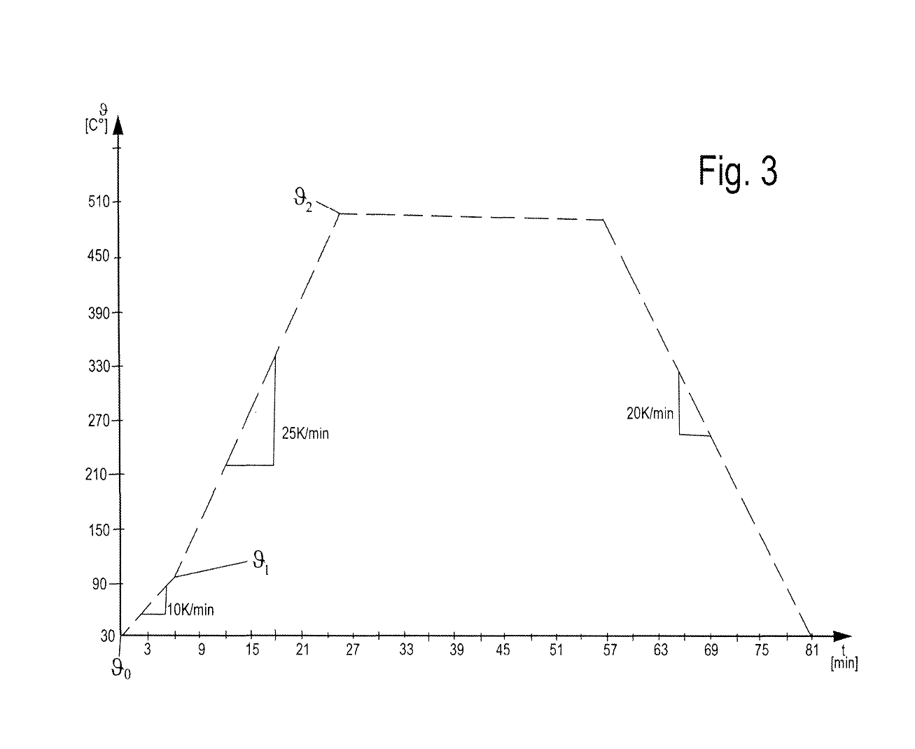

The application of the inorganic-organic hybrid polymer layer occurs by a sol-gel method, shown in FIG. 3, for example, for a polysiloxane coating.

In this embodiment, according to the present disclosure, the alkoxy compounds of the silicon are converted by hydrolysis and the substitution of the alkoxy functions by hydroxy groups into reactive silanols which are present in the sol as colloidal particles. During the application of the sol to a surface, which surface may be made of metal, these particles settle on the surface. The interactions between the silanol molecules and surface are further amplified by heating up until the formation of covalent bonds. The heating also leads to a conversion of the sol into the gel state by formation of polysiloxanes. Alcohols and water are formed in a condensation reaction in this process.

Various interactions between the organic and inorganic components of the hybrid polymers occur, for example, in alkoxy compounds of the silicon and other metals and metalloids. These are caused by covalent or ionic-covalent bonds.

The coating sol of the inorganic-organic hybrid polymers can be applied in a fluid manner in the sol-gel method onto a metallic component and can flow onto the metal component and cure under mild reaction conditions.

During the curing, a hydrolysis of the alkoxides, which catalyses in an alkaline or acidic manner, occurs, followed by the formation of a three-dimensional inorganic cross-linkage of a silicon oxide layer as a result of a condensation reaction.

Instead of the silicon as an inorganic component, it is within the scope of the present disclosure to use metals such as zirconium or titanium alkoxy compounds.

They can be added to tetramethoxysilane, that is, TMOS, in solvents, approximately ¼ of the volume of the TMOS, at first carefully at approximately 0° C. by slow addition, approximately two hours, for dissolving and suspension. The addition occurs in the range of between 0 and 10° C. because TMOS is easily flammable, poisonous and corrosive. Explosive vapor mixtures can form at temperatures from approximately 20° C. Subsequently, for the purpose of hydrolysis of the organic compound, concentrated hydrous HCl, approximately 1 to 3% by volume relative to the volume of the TMOS, is added under continuous stirring over 30 minutes. The HCl can be cooled off prior to this to a temperature of approximately 0° C. Subsequently, the stirring is maintained for a few minutes, for example, 5 to 10 min. The viscosity can be set accordingly by adding further solvent. The solvent can be protic or aprotic polar, for example, isopropanol.

Alternatively, a mixture mainly including 3-glycidyloxypropyl trimethoxysilane, that is, GPTS, and titanium tetraisopropylate can be converted under alkaline or acidic conditions by hydrolysis into a flowable coating substance and be converted into an in organic silicon dioxide layer by subsequent curing as a result of condensation at 700 to 800° C.

An intermediate layer is formed between the upper silicon dioxide layer with a thickness of 0.1 to 2 μm and the surface of the metallic component. The intermediate layer may include an increased fraction of metal compounds or elementary metals such as chromium, aluminum and/or manganese in addition to the silicon dioxide.

Depending on the metallic alloy that the coated component has, diffusion effects will occur in which the silicon will penetrate the metal surface and at the same time the number of metal compounds will diffuse into the silicon layer. The metallic component may optionally comprise a chromium-containing or aluminum-containing alloy, in which predominantly aluminum atoms will diffuse into the silicon layer by forming the intermediate layer.

The diffusion of chromium, manganese, aluminum and also nickel compounds into the silicon-containing layer is surprisingly larger than the diffusion of iron compounds into this layer. The diffusion of the metal compounds can be influenced, advantageously, by a temperature graduate during curing concerning the penetration depth and the concentration distribution in the layer.

The metal, such as aluminum, for example, can already be introduced as a component of the inorganic-organic hybrid polymer layer and can accumulate in the center of the coating as a result of diffusion and distribution effects.

Manganese can diffuse from the metal into the inorganic-organic hybrid polymer layer during heating and accumulate in this layer.

Moreover, at temperatures of 400 to 800° C. it is within the scope of the present disclosure to achieve higher penetration depths especially of chromium, manganese and aluminum atoms into the silicon layer and the silicon layer into the metallic surface of the component than would be possible at lower temperatures.

As a result of the reduced iron content in the intermediate layer, a passivating intermediate layer can be formed which is temperature-resistant even over 500° C., like the glass-like silicon cover layer.

The integrity of the layer is also maintained when the component, which is coated in such a way, is subjected for a short period of time, for example, approximately 30 minutes, to a welding flame of 1000 to 1500° C. As a result, the coating can also be applied to and be used in metallic components, at least in part which are weldable on an uncoated surface with another metallic surface. If the welding flame comes into contact with the coated region of the fitting, the coating is not destroyed.

The coating can also be applied to a chromized surface, according to the sol-gel method, with the chromium/silicon oxide coating flaking off only under higher load during subsequent bending of the component in comparison with a purely chromized surface.

The application of the fluids sol onto the surface of the metallic component can occur, for example, by spraying, dipping, or brushing, in accordance with the present disclosure.

The organic components of the inorganic-organic hybrid polymer can additionally cross-link three-dimensionally by the UV treatment, which provides the coating with advantageous mechanical properties.

In addition to the silicon atoms, it is within the scope of the present disclosure to incorporate further inorganic components, such as titanium oxide or silicon oxide, by encasing in a polysiloxane coating, by which the mechanical properties of the coating can also be improved. The further inorganic components can be incorporated as fine particles, for example, in the nanoscale range of between 40 nm and 500 nm.

In order to create a scratch-proof, ageing-resistant and corrosion-proof coating for the high temperature range, the inorganic-organic hybrid polymer layer is heated in temperature gradients to a temperature in the range of 400 to 600° C., with the organic components of the polymer preferably be oxidized. A cross-linkage density is thus created by the inorganic-organic hybrid polymer in conjunction with the sol-gel method which enables low layer thicknesses, for example, between 1.0 to 5.0 μm, for example, on a silicon-based polymer layer, and the incorporation of further nanoscale inorganic components, as well as dyes or pigments into the polymer layer.

The tempering time is between 40 minutes and three hours, or may be one hour at 200 to 800° C., or may be 300 to 600° C.

This polymer layer is quartz-like, tear-proof, mechanically resistant and protects the blank from corrosion. Moreover, it covers tarnishing colors of steel-containing materials such as the metallic lacquering.

The following table shows different test series, which state the cleaning capability of different component surfaces which were coated according to the method in accordance with the present disclosure.

| | | Surface test | Temperature load | NSS test | NSS test | NSS test | |
|---|---|---|---|---|---|---|---|
| Ser. | | Soiling | at 500° C. | according to | according to | according to | |
| No. | Surface | Compatibility | over 2 h | ISO 9227 16 h | ISO 9227 24 h | ISO 9227 96 h | Notes |
| 1 | 1.4016 | 6 K test | Yes | No | No | No | Limited cleaning |
| | | | | | | | effect |
| 2 | 1.4301 | 6 K test | Yes | No | No | No | Limited cleaning |
| | | | | | | | effect |
| 3 | PEEK | 6 K test | No | No | No | No | Good anti-adhesive |
| | | | | | | | effect and cleaning |
| 4 | PEEK with | 6 K test | 100 times | Results | Results | Results, | Full pyrolysis |
| | XP268 Nano | | | negative | negative | negative | capability |

The surfaces 1.4016 and 1.4301 are metallic surfaces of pull-out guides.

As shown in the table, the metallic components, with an inorganic-organic hybrid polymer coating, can be loaded at 500° C. over a prolonged period of time, so that the use in the high-temperature range is possible for such components. However, there is only a limited cleaning capability of the pull-out guides in this case.

The pull-out guide of the test series 3, which is coated with PEEK, cannot be loaded over two hours at 500° C., but shows an improved anti-adhesive effect and better cleaning in comparison with the examples 1 and 2.

A sol-gel coating in conjunction with a PEEK coating on a pull-out guide advantageously enables use in high-temperature operation and improved cleaning capability and therefore full pyrolysis capability.

FIG. 3 schematically shows a temperature diagram for the method of permanent coating of fittings, side grids and cooking-product supports for high-temperature applications. The coated blank is heated at first from ambient temperature a θ₀. It starts with a temperature gradient of approximately 10 K/min starting from an initial temperature θ₀ of 25° C. and then converges at a mean temperature of [symbol] ₁=100° C. into a temperature gradient of approximately 25 K/min. Upon reaching a target temperature [symbol] ₂ of 500° C., this is followed by a temperature level over 30 min. This is followed by a cooling phase with approximately 20 K/min back to [symbol] ₀.

A pull-out guide has been described in the above embodiments, in accordance with the present disclosure. It is within the scope of the present disclosure to provide other components with a coating in accordance with the within the present disclosure.

The cleaning of the metallic or plastic surface of the blank, prior to the application of the inorganic-organic hybrid polymer coating, can occur by different mechanical and/or chemical cleaning processes. Furthermore, additional surface treatment can be provided for roughing the surface, within the scope of the present disclosure.

When applying the inorganic-organic hybrid polymer layer, the flow behavior can be set in such a way that it will even adhere to perpendicular surfaces.

The component, in accordance with the present disclosure with the respective inorganic-organic hybrid polymer coating, offers advantages, for example, of scratch resistance, abrasion resistance, protection from corrosion, improved cleaning capability, and reduced adherence of dirt. In contrast to metallic coatings, it is transparent and can be applied to a dyed substrate.

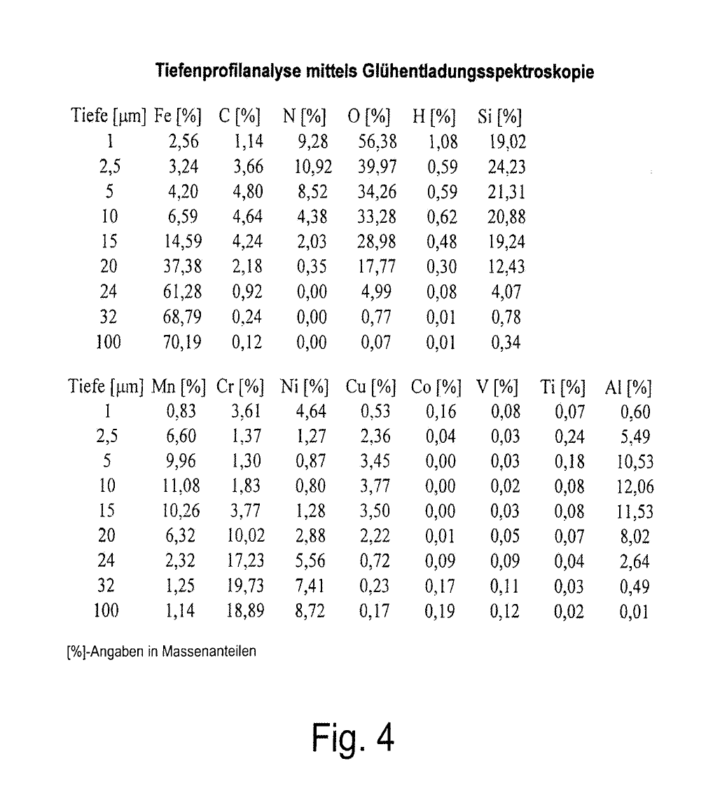

FIG. 4 shows, in a table, the elementary composition in mass concentrations along a depth profile of a component coated in accordance with the present disclosure.

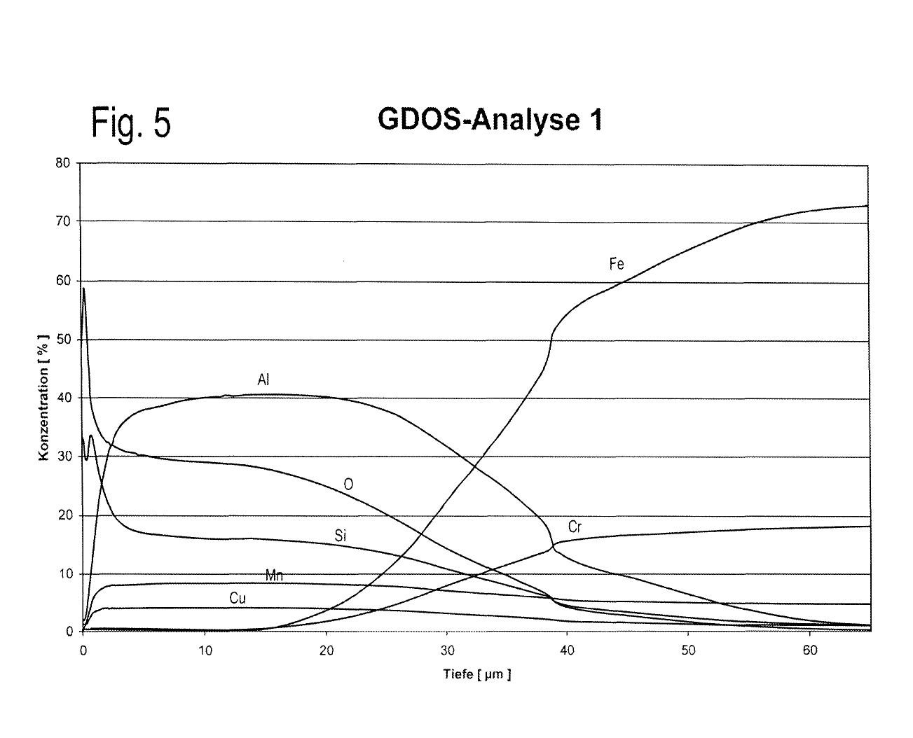

FIG. 5 shows a graphical representation of measured values of the elementary composition of the coated component over a depth profile of 0 to 65 μm. The step width of the measuring points is 0.5 μm in the range of 0 to 20 μm and 4 μm in the range of 20 to 65 μm. The elementary composition at 65 μm substantially corresponds to the composition of chromium steel of the metallic component before coating.

The measure data in FIGS. 4 and 5 were determined by optical glow discharge spectroscopy including sputter gas Ar 5.0 and an anode diameter of 2.5 mm.

The examined component is a profile section of a baking oven pull-out guide which was coated according to the method in accordance with the present disclosure. The component was thermally treated prior to examination with 100 pyrolysis cycles at 500° C. over 1.5 hours each.

The table of FIG. 4 shows examples of selected individual values of the spectroscopic determination using glow discharging.

At a layer thickness of 1 μm, the layer predominantly includes oxygen-containing compounds. Silicon oxide with a mass fraction of approximately 19% is predominantly represented. The fraction of oxidic silicon compounds is higher by approximately 1.6 times than the fraction of the metal oxides. Iron is contained in this region of the layer with a mass fraction of 2.6%.

At a layer thickness of 2.5 μm, the percentage mass fraction of the oxygen-containing compounds has decreased by approximately 10% in comparison with the composition with a layer thickness of 1 μm. The mass fraction of silicon compounds lies at 24%. The mass fraction of silicon compounds is still higher by 1.2 times than the mass fraction of the metallic compounds. The metal composition has changed over the composition of the layer at 1 μm.

The chromium and nickel fractions were reduced by 3 to 4% at a virtually constant iron fraction, whereas there was an increase in the aluminum fraction by a mass fraction of 5%, the manganese fraction by 6%, and the copper fraction by 1.5%.

The mass fraction, w related to aluminum, of the layer is 12.1% at a layer thickness of around 10 μm, and the manganese content was 11.1%. The silicon mass fraction was around 20.9%. The oxygen mass fraction was 33.3%. It is noteworthy that the iron fraction is merely 6.6% as compared with the aluminum and manganese content.

At a layer thickness of 15 μm, the iron mass fraction is already 14.6% and grows up to approximately 70% in the further progression of the profile.

The transition of the aluminum-, manganese- and silicon-rich and low-iron layer into an iron/chromium layer occurs at approximately 20 μm.

The composition at 100 μm substantially represents the elementary composition of the employed chromium steel.

FIG. 5 shows a rise in the concentration of aluminum to 40% and manganese to 8% in the coating, with the concentrations reaching their maximum in the region of between 10 to 20 μm and decreasing thereafter again.

At the same time, a concentration plateau concerning the silicon concentration is formed at 15 to 17%, which extends over a range of 4 μm to 22 μm.

A rise in the iron and chromium concentration to a concentration of 73%, for iron, and 80%, for manganese, can be observed in the range of between 20 to 50 μm.

As was surprisingly noticed, there was a diffusion and distribution of aluminum and manganese compounds in the silicon-containing layer after the application of the inorganic-organic silicon-containing hybrid polymer layer in the sol-gel method and a heating of the coating to 550 to 800° C., or possibly 650 to 750° C.

Numerous possibilities for applications are obtained by the thus obtained two-layer coating. The surface can be arranged according to customer requests by coloring the layer. The leveling of the surface by application of the coating leads to an improved cleaning capability of the surface and an appealing visual appearance.

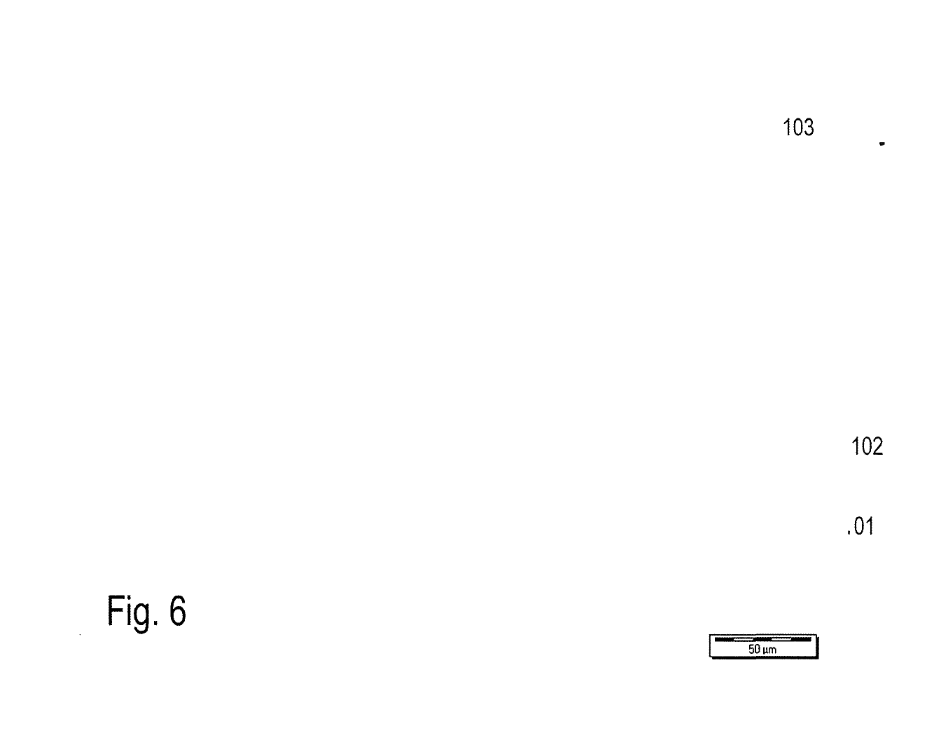

FIG. 6 shows a light-microscopic representation of the layered configuration of the coated component at a scale of 50 μm.

The silicon oxide cover layer 101 is shown in FIG. 6.

The intermediate layer 102 is arranged beneath the cover layer 101, which intermediate layer 102 predominantly includes manganese and aluminum compounds in addition to silicon compounds. The intermediate layer 102 has an inhomogeneous configuration, which is confirmed by a plurality of darker and brighter points in the grey layer. These focal points of concentration are smaller and distributed more evenly in the intermediate layer than is the case in the steel layer 103 which is arranged beneath the intermediate layer 102.

FIG. 6 shows or suggests that the intermediate layer thickness is 20 to 30 μm.

The following paragraph includes measured values that indicate the composition of the surface, for example, the silicon oxide cover layer 101, as mass fractions in percent.

Silicon: 36.2%, oxygen: 35.4%, aluminum: 10.9%, manganese: 5.4%, iron: 2.3%, copper: 4.0%, potassium: 0.7%, titanium: 0.6%, niobium: 4.0%, sodium: 0.7%, and calcium: 0.1%.

The measured values are the averaged values of a triple measurement, with the measured values being subjected to an average fluctuation margin of 5%, relating to the averaged value.

The measurement occurred by an energy-dispersive x-ray spectroscopy, that is, EDX.

The method of energy-dispersive x-ray spectroscopy for material examination utilizes the x-rays emitted by a sample for the examination of the element composition. For this purpose, the atoms in the sample are excited by an electron ray. They will emit x-rays with an element-specific energy.

These measured value results of EDX substantially support the results of the glow discharge spectroscopy.

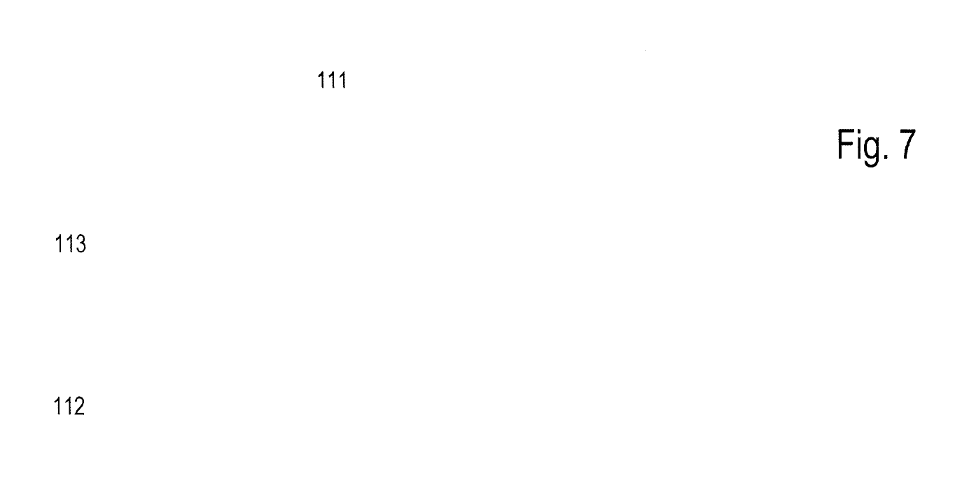

FIG. 7 shows a scanning electron microscopic recording of a cross-section of the coating in accordance with the present disclosure.

The measurements were performed with a Zeiss REM-DSM 962 with an accelerating voltage of 20 kV and approximately 500 times magnification at a working distance of approximately 23 mm.

The surface of the coating shows a thin white layer of a thickness of approximately 1 to 2 μm, which is recognizable as the silicon oxide cover layer 111.

An intermediate layer 112, with a thickness of approximately 20 μm, is arranged beneath the cover layer 111, which intermediate layer 112 is mainly made of silicon dioxide, aluminum, iron and oxygen.

The substrate material 113 of the metallic component is arranged beneath.

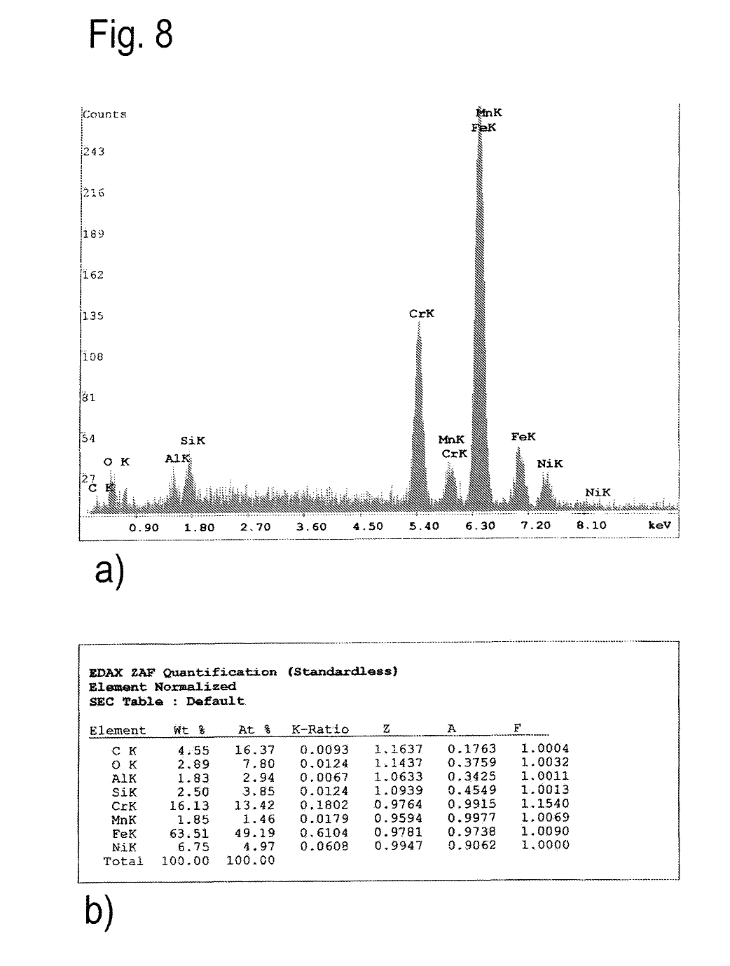

FIGS. 8 to 10 show spectra which were recorded with a combination of the measurements of a scanning electron microscope with an energy-dispersive x-ray emission analysis, or EDX.

This scanning electron microscope, as mentioned above, was combined with an EDX, for example, EDAX Genesis. The EDX has an energy resolution of 10 eV/ch and a counting rate of approximately 14,000 pulses per second.

FIG. 8 shows a spectrum of an examined region of the previously mentioned coated profile section which was intentionally removed from coating and was treated under the same conditions, that is, 500° C., 100 pyrolysis cycles of 1.5 hours each. The uncoated surface predominantly includes iron (63%) and chromium (16%), as well as nickel (6.75%), manganese (1.85%), carbon (4.55%), oxygen (2.89%), aluminum (1.83%) and silicon (2.50%).

The substrate material 113 of the metallic component therefore concerns an alloyed steel of the class of the chromium steels.

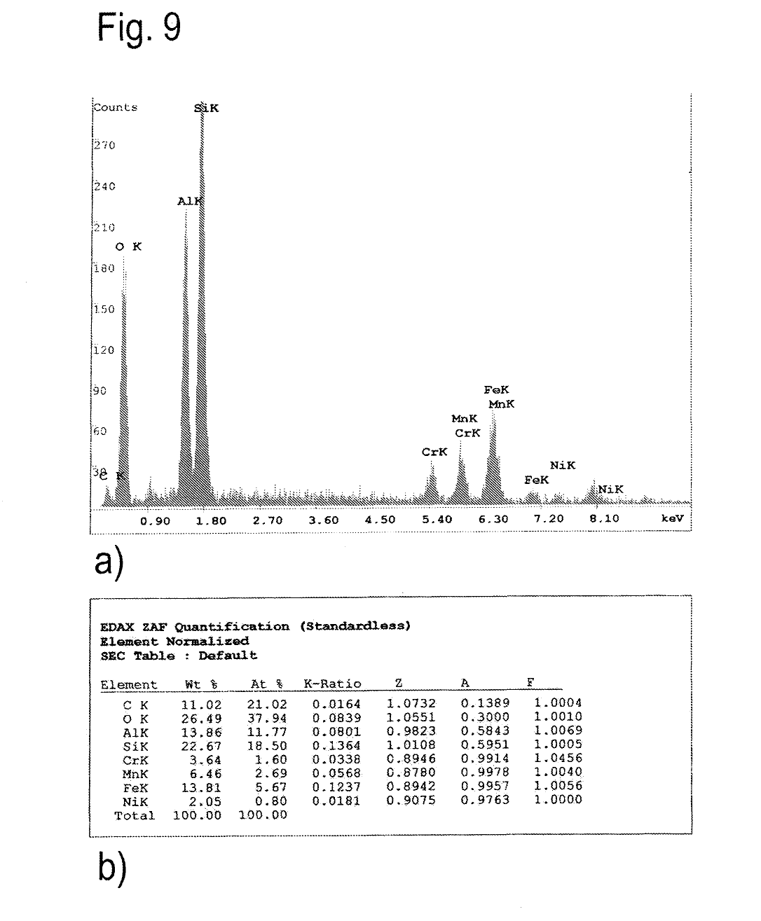

FIG. 9 shows a spectrum of the region of intermediate layer 112. This region predominantly includes silicon (22.67%), oxygen (26.49%), iron (13.81%) and aluminum (13.86%), as well as nickel (2.05%), manganese (6.46%), carbon (11.02%) and chromium (3.64%).

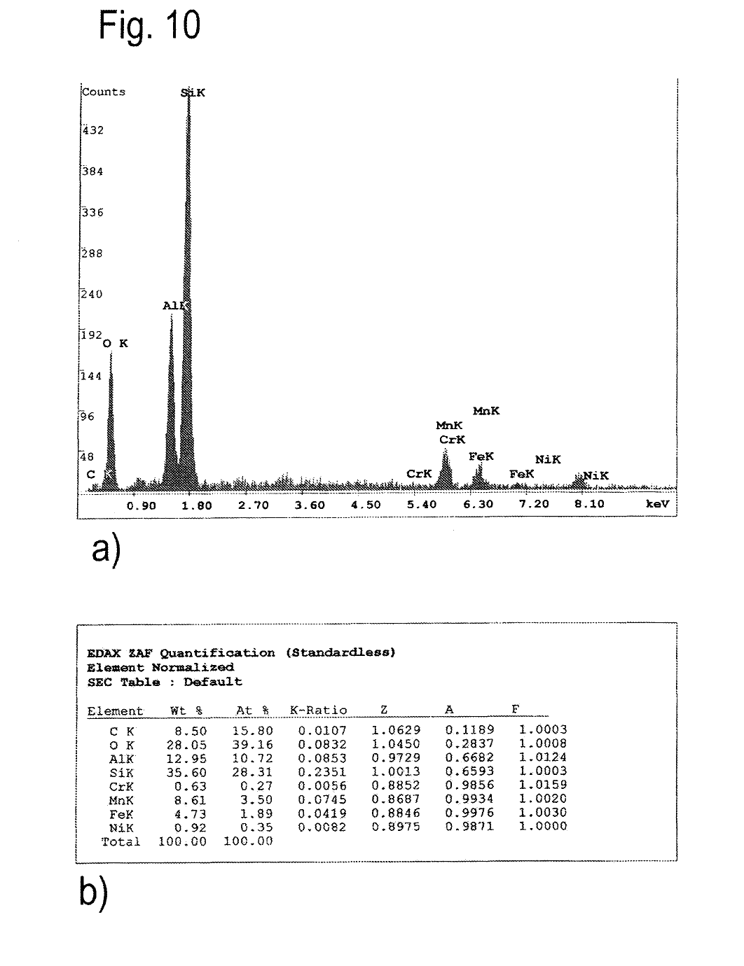

FIG. 10 shows a spectrum of the region of silicon cover layer 111. This region predominantly comprises silicon (35.6%), oxygen (28.05%) and aluminum (12.95%), as well as iron (4.73%), nickel (0.92%), manganese (8.61%), carbon (8.50%) and chromium (0.63%).

These measured values show that the silicon cover layer is predominantly made of oxidic silicon and aluminum compounds, for example, more than 50%.

The silicon-containing intermediate layer with a thickness of 10 to 40 μm, for example, includes at least 10% of silicon and 10% of a metal, which may be aluminum, with the percentages relating to percent by weight.

It is within the scope of the present disclosure that, with the help of the inorganic-organic hybrid polymer coating, to ensure a transparent coating on metallic blanks which offer high scratch resistance as compared with uncoated components and reproduce the special steel color, partly also by avoiding tarnishing.

running intervals were performed after the respective pyrolysis cycles at 500° C. in order to evaluate the functionality of such a transparent pull-out guide. The following test criteria were provided:

a) Expenditure of force in pulling out the pull-out guide (Fa) in N
b) Expenditure of force in retracting the pull-out guide (Fe) in N
c) Running quality, evaluated by trained testing person by an ordinal scale
d) Noises, evaluated by trained testing person by an ordinal scale

The running quality and the noise quality of a coated pull-out guide after 15 pyrolysis cycles (500° C.) at a test load of 10 to 15 kg were associated with running quality classes 1 to 3.

The results of the measurement show a constant good running quality, that is, classification 1 to 7, with 1 corresponding to the highest running quality and 7 to the lowest running quality.

The results of the measurement also show a constant low-noise mobility, that is, classification 1 to 7, with 1 corresponding to no noise generation and 7 to the highest possible noise generation.

The forces that were applied to pulling out the coated pull-out guide lie in the range of less than 10 N, or possibly between 3.0 to 4.5 N.

The forces that were applied to retracting the coated pull-out guide lie in the range of less than 11 N, or possibly between 4.0 to 8 N.

The described coatings may be applied to a metallic component, the substrate material of which includes a steel with material number 1.4301, and 18/10 chromium-nickel steel, steel with material number 1.4016, a ferritic 17% chromium steel or steel with the material number 1.4310, a chromium-nickel-alloyed steel.

The coating, according to the present disclosure, provides special advantages in high-temperature applications, especially in baking ovens. It also provides advantages in components in areas with a high likelihood of corrosion. This also includes the products of white wares, for example, such as refrigerators and washing machines. Furniture fittings are subjected to a higher likelihood of corrosion by humid climate and/or seawater during transport, especially during maritime transport. In these areas, the coated fittings, in accordance with the present disclosure, have a longer service life as compare with non-coated fittings.

Although the present disclosure has been described and illustrated in detail, it is to be clearly understood that this is done by way of illustration and example only and is not to be taken by way of limitation. The scope of the present disclosure is to be limited only by the terms of the appended claims.

We claim:

1. A method for the production of a component, the method steps comprising:
providing a blank;
applying an inorganic-organic hybrid polymer layer to a surface of the blank to form a coated blank;
heating the coated blank until a curing of the polymer layer occurs; and
cooling the coated blank.

2. The method according to claim 1, wherein the applying of the inorganic-organic hybrid polymer layer onto the surface of the blank occurs by a sol-gel method, which sol-gel method comprises the following steps:
formation of a sol by hydrolysis;
applying the sol onto the surface of the blank; and
forming an adhesive gel layer by polycondensation.

3. The method according to claim 2, wherein the applying of the inorganic-organic hybrid polymer layer onto the surface of the blank includes polyetheretherketone and occurs according to the sol-gel method.

4. The method according to claim 2, wherein the applying of the sol in the applying of the inorganic-organic hybrid polymer layer occurs by spraying onto the surface of the blank.

5. The method according to claim 1, further comprising the step of curing of the inorganic-organic hybrid polymer layer by ultraviolet radiation, which step is performed between either the applying and heating steps or after the heating step.

6. The method according to claim 2, wherein further inorganic materials are added to the sol, including one or both of silicon oxide and titanium oxide.

7. The method according to claim 1, wherein the inorganic-organic hybrid polymer layer includes a silicon-, aluminum- or titanium-containing inorganic-organic hybrid polymer having a temperature resistance up to 600° C.

8. The method according to claim 1, wherein in a heat-up phase, a first time-dependent temperature gradient is 8 to 12 K/min up to a middle temperature and a second time-dependent temperature gradient is 12 to 30 K/min up to a target temperature.

9. The method according to claim 1, wherein the coated blank is tempered at least 25 minutes, at a target temperature of 450 to 550° C.

10. The method according to claim 1, wherein the coated blank is tempered at least 25 minutes, at a target temperature of 650 to 750° C.

11. The method according to claim 9, wherein the target temperature is kept constant over a period of 25 to 40 minutes.

12. The method according to claim 11, wherein a time-dependent temperature gradient of controlled cooling of the blank is 15 to 25 K/min.

13. The method according to claim 9, characterized wherein the coated blank is tempered in a forced-air method with an air throughput of 50 to 70 L/min.

14. The method according to claim 1, wherein the surface of the blank is smoothed prior to the applying of the inorganic-organic hybrid polymer layer.

15. The method according to claim 1, wherein a metal compound of one or both of aluminum and manganese is diffused into the hybrid polymer layer during the heating of the coated blank for protection from corrosion.

16. The component, for use in domestic appliances, the component comprising a coating produced according to the method of claim 1.

17. The component according to claim 16, wherein the inorganic-organic hybrid polymer layer includes either a dye or pigments.

18. The component according to claim 16, wherein the hybrid polymer layer includes at least a mass fraction of a metal of at least 12%, the metal including, one or both of aluminum and manganese, for protection from corrosion.

19. The component according to claim 1, wherein the component includes a substrate metallic base body, an intermediate layer arranged above the base body, and which intermediate layer includes silicon oxide and at least one metal, the at least one metal including one or both of aluminum and manganese, and the component further includes a cover layer including silicon oxide, the intermediate layer forming a protection from corrosion of the substrate in case of injury of the cover layer.

20. The component according to claim 19, wherein the cover layer has a mass fraction, for at least silicon, of at least 35%.

21. The component according to claim 19, wherein the intermediate layer has at least one mass fraction, of aluminum, of between 10 to 12%.

22. The component according to claim 19, wherein the intermediate layer thickness of the coating is 20 to 30 μm.

23. The component according to claim 16, wherein the component is arranged as a rail of a pull-out guide for baking ovens.

24. The component according to claim 16, wherein the component is configured to be used as a rail in domestic appliances, the domestic appliances including one or more of baking ovens, refrigerators, washing machines, and a furniture fitting.

25. The method according to claim 1, wherein the inorganic-organic hybrid polymer layer includes a silicon-, aluminum- or titanium-containing inorganic-organic hybrid polymer having a temperature resistance up to 800° C.

26. The method according to claim 1, wherein the coated blank is tempered at least 20 minutes, at a target temperature of 200 to 600° C.

27. The method according to claim 1, wherein the coated blank is tempered at least 20 minutes, at a target temperature of 500 to 800° C.

28. The method according to claim 9, wherein the target temperature is kept constant over a period of 15 to 90 minutes.

29. The method according to claim 11, wherein a time-dependent temperature gradient of controlled cooling of the blank is 5 to 40 K/min.

30. The method according to claim 9, wherein the coated blank is tempered in a forced-air method with an air throughput of 30 to 90 L/min.

31. The component according to claim 16, wherein the hybrid polymer layer includes at least a mass fraction of a metal of 7%, the metal including, one or both of aluminum and manganese, for protection from corrosion.

32. The component according to claim 19, wherein the cover layer has a mass fraction, for at least silicon, of at least 30%.

33. The component according to claim 19, wherein the intermediate layer has at least one mass fraction, for at least aluminum, of 7%.

34. The component according to claim 19, wherein the intermediate layer thickness of the coating is 10 to 40 μm.
